(19) United States
(12) Patent Application Publication
(10) Pub. No.: US 2024/0367419 A1
(43) Pub. Date: Nov. 7, 2024

(54) FIBER-REINFORCED ORIENTED STRAND BOARD

(71) Applicant: LOUISIANA-PACIFIC CORPORATION, NASHVILLE, TN (US)

(72) Inventor: NEIL FREIDBERG, LEBANON, TN (US)

(21) Appl. No.: 18/657,562

(22) Filed: May 7, 2024

Related U.S. Application Data
(60) Provisional application No. 63/464,594, filed on May 7, 2023.

(51) Int. Cl. B32B 21/10; B32B 5/02; B32B 21/02; B32B 37/06; B32B 37/10; B32B 37/18

(52) U.S. Cl. CPC B32B 21/10; B32B 5/024; B32B 5/028; B32B 21/02; B32B 37/06; B32B 37/10; B32B 37/18; B32B 2260/021; B32B 2260/046; B32B 2262/101; B32B 2262/106; B32B 2305/08; B32B 2305/188; B32B 2305/38; B32B 2317/16; B32B 2607/00

(57) ABSTRACT

A multi-layer panel or board with multiple layers of oriented strands, such as a bottom layer, a core layer, and a top layer, with one or more integrated fiber reinforcement layers incorporated therein. The fiber reinforcement layer may comprise a plurality of fibers, fiberglass, “kitty hair”, or carbon fiber mat, mesh, or screen, and may be placed between a core strand layer and a top strand layer, and/or a core strand layer and a bottom strand layer. The form of the layer could be a solid layer (e.g., fiberglass), a mesh or screen, a woven-fiber mat, a hexagonal mesh (i.e., “chicken-wire”), or the like. The reinforcement layer may be pre-formed prior to placement in the mat, or may be formed during placement. More than one reinforcement layer may be present, and reinforcement layers may also be integrated within a strand layer.

This application claims benefit of and priority to U.S. Provisional App. No. 63/464,594, filed May 7, 2023, which is incorporated herein in its entirety by specific reference for all purposes.

### FIELD OF INVENTION

This invention relates to a multi-layered, fiber-reinforced engineered-wood composite panel (which can be wood composite or wood-based panels, such as oriented strand board (OSB), plywood, or other cellulose-based panels) used for exterior applications such as, but not limited to, siding, trim, fencing wall sheathing, roof sheathing, or other sheathing.

### BACKGROUND OF THE INVENTION

Building wall and roof assemblies are commonly comprised of layers of several materials, each performing a specific function, that are installed separately. A typical assembly for residential home construction would include a dimension lumber frame, a plywood or oriented strand board (OSB) sheathing layer and a siding. In some cases, the sheathing and siding can be the same layer, such as a panel siding that is code approved as a sheathing. Wood-based composites, such as OSB, have been found to be acceptable alternatives to veneer-based wood paneling (e.g., softwood plywood) and dimension wood products.

In general, wood-based composites include oriented strand board (OSB), wafer board, flake board, particle board as well as medium density fiberboard (MDF). These wood-based composites are typically formed from a wood material combined with a thermosetting adhesive to bind the wood substrate together. In some processes, the adhesive is combined with other additives to impart additional properties to the wood composites. Additives can include fire retardants, fungicides/mildewcides, insecticides and water repellents. These ingredients can also be added separately from the adhesive, for example when this is more compatible with the manufacturing process. A significant advantage of strand and particle-based wood composites is that they have many of the properties of plywood and dimension lumber but can be made from a variety of lower grade wood species, smaller trees and waste from other wood product processing, and can be formed into panels in lengths and widths independent of size of the harvested timber.

One class of alternative products are multilayer oriented wood strand board products, particularly those with a targeted layer-to-layer oriented strand pattern, such as OSB. These oriented strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on the mat-forming line with the strands of the face layers predominantly oriented in a parallel to machine direction orientation and strands in the core layer oriented, generally, perpendicular to the face layers (e.g., cross-machine) direction.

In one common commercial process these layers are bonded together using natural or synthetic adhesive resins under heat and pressure to make the finished product. Oriented, multilayer wood strand boards of the above-described type can be produced with mechanical and physical properties comparable to those of commercial softwood plywood and are used interchangeably, such as for wall and roof sheathing. In certain types of construction, these panels (and other construction materials) may be required by building codes to meet certain durability requirements, such as fire, wind and water resistance.

Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, 6,461,743, and U.S. patent application Ser. No. 17/747,930, all of which are incorporated herein in their entireties by specific reference for all purposes.

### SUMMARY OF INVENTION

In various exemplary embodiments, the present invention comprises a multi-layer oriented strand board (OSB) panel or board for use in interior and/or exterior applications such as, but not limited to, siding, trim, fencing, wall sheathing, roof sheathing, or other sheathing. The multi-layer panel or board comprises multiple layers of oriented strands, such as a bottom layer, a core layer, and a top layer, with one or more integrated fiber reinforcement layers incorporated therein.

A fiber reinforcement layer may comprise a plurality of fibers, fiberglass, “kitty hair”, or carbon fiber mat, mesh, or screen, and may be placed between a core strand layer and a top strand layer, and/or a core strand layer and a bottom strand layer. The form of the layer could be a solid layer (e.g., fiberglass), a mesh or screen, a woven-fiber mat, a hexagonal mesh (i.e., “chicken-wire”), or the like.

The reinforcement layer may be pre-formed prior to placement in the mat, or may be formed during placement. For example, a plurality of loose fibers may be distributed on or spread over the top of an OSB mat layer after that mat layer has been laid down or formed. In OSB mats with more than three layers, a fiber reinforcement layer may be placed between any two adjacent strand layers.

The thickness of a fiber reinforcement layer may vary, and where multiple layers are used, the thickness of each may be the same, or the thickness may vary based on their position in the multi-layer mat. In one embodiment, for example, the reinforcement layer comprises fiberglass in a range of about 1 mil to about 18 mils in thickness.

### BRIEF DESCRIPTION OF THE DRAWINGS

FIG. 1 shows a cross-section view of a fiber-reinforced OSB mat or panel with a fiber reinforcement layer between the core strand layer and top strand layer, in accordance with an embodiment of the present invention.

FIG. 2 shows a cross-section view of a fiber-reinforced OSB mat or panel with a fiber reinforcement layer between the core strand layer and bottom strand layer.

FIG. 3 shows a cross-section view of a fiber-reinforced OSB mat or panel with two fiber reinforcement layers.

FIG. 4 shows a cross-section view of a fiber-reinforced OSB mat or panel with a fiber reinforcement layer between the core strand layer and bottom strand layer, and a second fiber reinforcement layer integrated within the upper strand layer.

FIG. 5 shows a method of producing a fiber-reinforced OSB mat or panel with one or two fiber reinforcement layers, in accordance with an embodiment of the present invention.

### DETAILED DESCRIPTION OF EXEMPLARY EMBODIMENTS

In various exemplary embodiments, the present invention comprises a multi-layer oriented strand board (OSB) panel or board 2 for use in interior and/or exterior applications such as, but not limited to, siding, trim, fencing, wall sheathing, roof sheathing, or other sheathing. The multi-layer panel or board 2 comprises multiple layers of oriented strands, such as a bottom layer 10b, a core layer 10c, and a top layer 10a, with one or more integrated fiber reinforcement layers 20 incorporated therein.

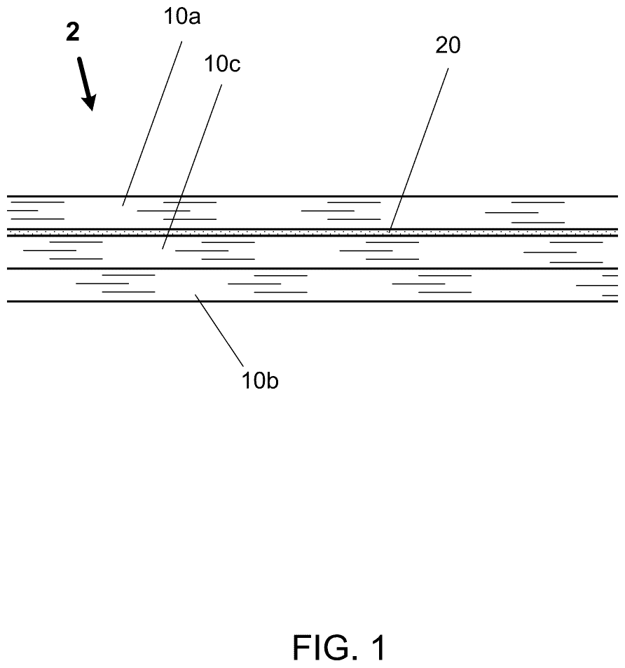

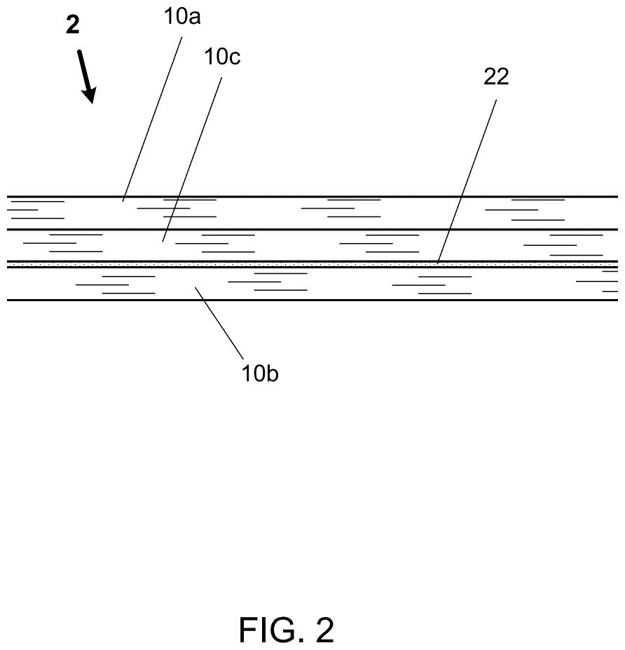

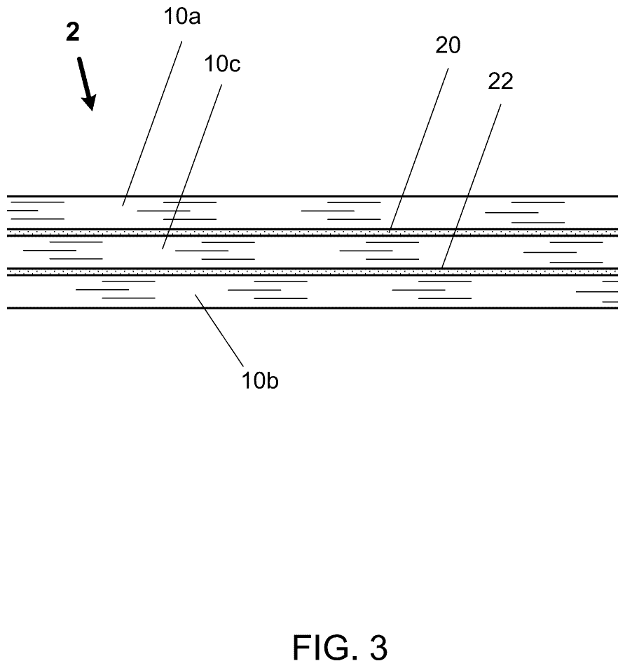

FIGS. 1-3 show cutaway side views of several exemplary arrangements of fiber reinforcement layers with stand layers. FIG. 1 shows a fiber reinforcement layer 20 between the upper surface of the core layer 10c and the lower surface of the top layer 10a. FIG. 2 shows a fiber reinforcement layer 22 between the upper surface of the bottom layer 10b and the lower surface of the core layer 10c. FIG. 3 shows an embodiment with two fiber reinforcement layers 20, 22, located between the respective surfaces of the adjacent strand layer.

A fiber reinforcement layer 20, 22 may comprise a plurality of fibers, fiberglass, “kitty hair”, or carbon fiber mat, mesh, or screen, and may be placed between a core strand layer and a top strand layer, and/or a core strand layer and a bottom strand layer. The form of the layer 20, 22 could be a solid layer (e.g., fiberglass), a mesh or screen, a woven-fiber mat, a hexagonal mesh (i.e., “chicken-wire”), or the like.

The reinforcement layer 20, 22 may be pre-formed prior to placement in the mat, or may be formed during placement. For example, a plurality of loose fibers may be distributed on or spread over the top of an OSB mat layer after that mat layer has been laid down or formed. In OSB mats with more than three layers, a fiber reinforcement layer may be placed between any two adjacent strand layers, as seen in FIGS. 1-3.

The thickness of a fiber reinforcement layer may vary, and where multiple layers are used, the thickness of each may be the same, or the thickness may vary based on their position in the multi-layer mat. In one embodiment, for example, the reinforcement layer comprises fiberglass in a range of about 1 mil to about 18 mils in thickness.

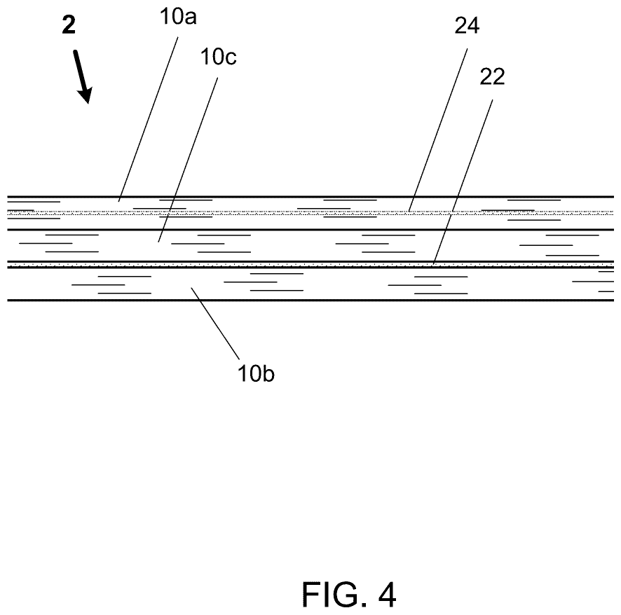

In some circumstances, a fiber reinforcement layer may be placed within one or more of the strand layers. This arrangement is particularly useful when the fiber reinforcement layer is thin and has an open configuration (e.g., a mesh or screen form). FIG. 4 shows an example of a fiber reinforcement layer 22 between the upper surface of the bottom layer 10b and the lower surface of the core layer 10c (similar to the positioning shown in FIG. 2), with a second fiber reinforcement layer 24 placed within the upper strand layer 10a.

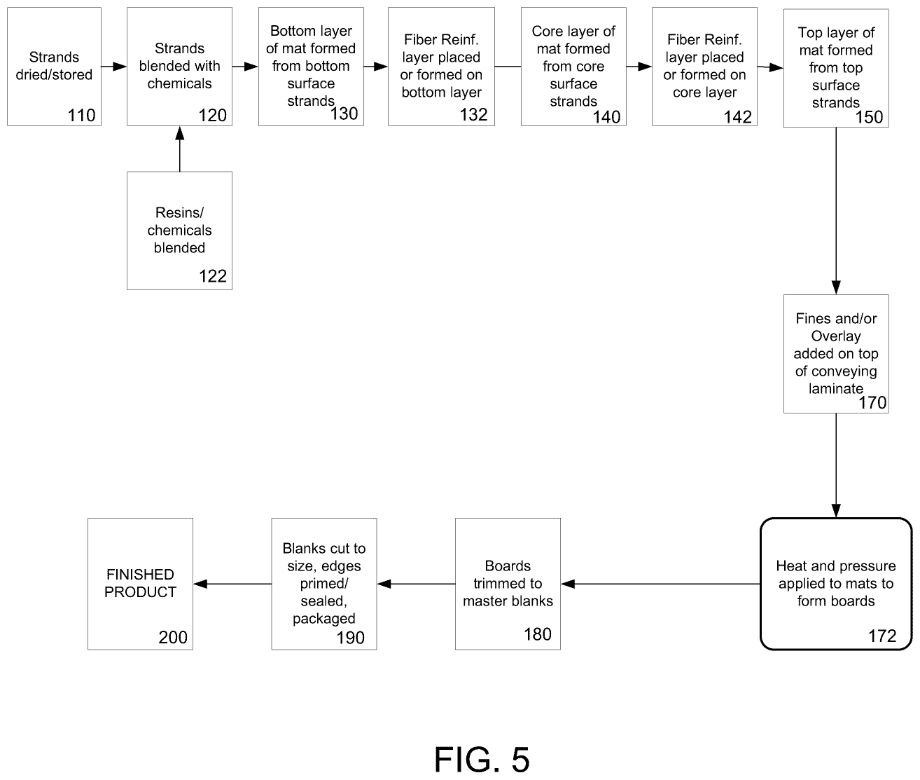

FIG. 5 shows the steps of a method of producing the OSB board or panel with fiber reinforcement layers. These steps include the drying and storing of wood strands 110, the treatment or blending 120 of designated strands (e.g., bottom, core, top, or all strands) with applicable chemicals and/or additives (e.g., wax, resin, and the like) 122, and the forming of the appropriate strand layers in order on a forming line (first bottom surface, then core, then top surface) using designated strands, 130, 140, 150. After the bottom strand layer is formed, a fiber reinforcement layer may be added to the mat by placing or forming the fiber reinforcement layer on the upper surface of the bottom strand layer 132. The core layer would be formed 140 on top of the fiber reinforcement layer, if present, or on the upper surface of the bottom strand layer directly if there is no intervening fiber reinforcement layer. Likewise, a fiber reinforcement layer may be added to the mat by placing or forming the fiber reinforcement layer on the upper surface of the core strand layer 142. The top strand layer is then placed on this fiber reinforcement layer or directly on the core strand layer if there is no intervening fiber reinforcement layer.

Any fines and/or any performance overlay that may be incorporated into the board or panel may then be placed on the top of the mat 170, which is then placed into a primary press (which typically is a multi-layer press) for application of heat and pressure to the mat to form boards 172. These boards are then subjected to subsequent trimming 180 and processing (e.g., panels cut to size, edges primed/sealed, and packaging) 190 to produce the finished product 200.

Thus, one or more fiber reinforcement layers are formed (if the fiber reinforcement layer is not pre-formed) and placed in the mat in conjunction with corresponding OSB strand layers during formulation of the mat on a production line pre-press. The fiber reinforcement layer or layers are integrated with and bond with the strand layers when subjected to heat and pressure during the pressing process. The resin in the oriented strand layers helps promote this bonding, but additional resin may be added to the reinforcement layer. For example, if the fiber reinforcement layer is pre-formed, the additional resin may be added to one or both surfaces of the layer, and/or on the corresponding surface of the adjacent OSB strand layer or layers. If the fiber reinforcement layer is not pre-formed, the fibers or elements being used to form the layer may be blended or mixed with resin prior to placement during formulation of the mat, or the additional resin may be added to top surface of the underlying OSB strand layer prior to the placement of the fiber reinforcement layer's fibers or elements, and additional resin may also be added to the top surface of the fiber reinforcement layer after placement.

It should be noted that the materials used for the fiber reinforcement layer would need to be able to withstand the temperatures and pressure of the primary press.

The fiber-reinforced OSB panel or board with one or more fiber reinforcement layers has increased strength and better protection against conditions such as hurricanes, tornadoes, or other sources of projectile-based damage. The panel or board can be used as regular internal and/or external sheathing in a wall or roof structure, and may be used with separate or integrated weather or water resistant barriers (WRBs), radiant barriers, insulation, foam, and other configurations of materials used with standard OSB panels and boards. For example, a fiber-reinforced OSB board or panel may have an integrated

WRB or a continuous layer of insulation attached. The panel or board may also be used as independent protective boarding used in case of a hurricane, tornado, or other forms of storms to cover and protect windows, doors, and openings on buildings or other structures.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for producing a fiber-reinforced wood composite panel, comprising the steps of:
forming a strand mat with two or more strand layers, each strand layer comprising a plurality of wood strands;
adding a fiber reinforcement layer within the strand mat between two adjacent strand layers; and
applying pressure and heat by a press to the strand mat with fiber reinforcement layer to form a fiber-reinforced wood composite board;
wherein the fiber reinforcement layer comprises one or more of: a plurality of fibers; fiberglass; and a carbon fiber mat.

2. The method of claim 1, wherein the fiber reinforcement layer comprises a mesh or screen.

3. The method of claim 1, wherein the fiber reinforcement layer comprises a plurality of woven fibers.

4. The method of claim 1, wherein the step of adding a fiber reinforcement layer comprises placing a pre-formed fiber reinforcement layer on the surface of a lower strand layer, followed by forming an upper strand layer on the pre-formed fiber reinforcement layer.

5. The method of claim 1, wherein the step of adding a fiber reinforcement layer comprises placing loose fiber elements to form a fiber reinforcement layer on the surface of a lower strand layer, followed by forming an upper strand layer on the formed fiber reinforcement layer.

6. The method of claim 1, comprising the step of adding a second fiber reinforcement layer within the strand mat between two adjacent strand layers, wherein the second fiber reinforcement layer is not in the same location in the mat as the fiber reinforcement layer.

7. The method of claim 1, comprising the step of adding a second fiber reinforcement layer within the strand mat within and integrated with one of said two or more strand layers.

8. A fiber-reinforced wood composite product produced according to claim 1, comprising:
two or more strand layers, each strand layer comprising a plurality of wood strands;
a first fiber reinforcement layer positioned between two adjacent strand layers and attached thereto by heat and pressure;
wherein the fiber reinforcement layer comprises one or more of: a plurality of fibers; fiberglass; and a carbon fiber mat.

9. The product of claim 8, wherein the first fiber reinforcement layer comprises a mesh or screen.

10. The product of claim 8, wherein the fiber first reinforcement layer comprises a plurality of woven fibers.

11. The product of claim 8, wherein the fiber reinforcement layer is a pre-formed fiber reinforcement layer.

12. The product of claim 8, wherein the fiber reinforcement layer comprises loose fiber elements bonded together and to the adjacent strand layers by said heat and pressure.

13. The product of claim 8, wherein there are a bottom strand layer, a core strand layer, and a top strand layer.

14. The product of claim 13, wherein the first fiber reinforcement layer is positioned between the core strand layer and the top strand layer.

15. The product of claim 13, wherein the first fiber reinforcement layer is positioned between the core strand layer and the bottom strand layer.

16. The product of claim 8, further comprising a second fiber reinforcement layer, wherein one of the fiber reinforcement layers is positioned between the core strand layer and the top strand layer, and the other one of the fiber reinforcement layers is positioned between the core strand layer and the bottom strand layer.

17. The product of claim 8, further comprising an additional fiber reinforcement layer within and integrated with one of said two or more strand layers.
